(19) United States
(12) Patent Application Publication
(10) Pub. No.: US 2004/0210842 A1
(43) Pub. Date: Oct. 21, 2004

(54) Portable computing system for editing and linking text and mathematical expressions

(76) Inventor: Jaffer Qamar, San Francisco, CA (US)

Correspondence Address: JAFFER QAMAR, SMARTPAD, INC., STE# 1, 98 CERVANTES BLVD, SAN FRANCISCO, CA, 94123, US

(21) Appl. No.: 09/866,464

(22) Filed: May 23, 2001

Related U.S. Application Data
(60) Provisional application No. 60/206,249, filed on May 23, 2000.

(51) Int. Cl. G06F 17/21

(52) U.S. Cl. 715/538; 715/501.1

(57) ABSTRACT

A simple method and an inexpensive portable device to enter expressions in which the expressions can be linked and automatically updated at all links whenever one particular instance of the linked expression is revised; and, the results, for the mathematical expressions, are automatically re-computed, updated, saved and auto-displayed.

### CROSS-REFERENCES TO RELATED APPLICATIONS

This application claims priority from co-pending U.S. Provisional Patent Application No. 60/206,249 filed May 23, 2000 entitled METHOD AND APPARATUS EDITING, AUTO-COMPUTING, LINKING AND AUTO-UPDATING which is hereby incorporated by reference, as if set forth in full in this document, for all purposes.

### COPYRIGHT NOTICE

A portion of the disclosure recited in the specification contains material which is subject to copyright protection. Specifically, a source code appendix in accordance with 37 CFR Section 1.96 is included that lists source code instructions for a process by which the present invention is practiced in a computer system. The source code appendix is provided on a Compact Disk—Read Only Memory (CDROM) in accordance with recent Patent and Trademark Office guidelines. The copyright owner has no objection to the facsimile reproduction of the specification as filed in the Patent and Trademark Office. Otherwise all copyright rights are reserved.

### BACKGROUND OF THE INVENTION

This invention is related in general to portable computing and more specifically to a system for integrating text with calculations and for linking updates among multiple documents.

In most applications, users may select data of any format, copy it to a clipboard and paste it to another location. In doing so, links are not created between the root-data and the pasted-data. Consequently, if the root-data is revised, the pasted-data is not updated. Existing software applications require users to revise the data in every instance where it has been pasted. Sometimes, the Find method is used to search an alphanumeric string, and the Replace method is used to revise the various instances. There is a need for a procedure that automatically modifies the pasted-data, at some or all of the occurrences, when the root-data is revised.

In many applications, hyperlinks, when clicked, move the cursor from its current location to the linked location either in the same file or another file. Hyperlinked expressions are not necessarily pasted instances and, therefore, revision to the root-expression does not modify the linked-object.

In spreadsheets and databases, links can be created between cells and data-fields, respectively. However, links between pasted expressions are not existent in any application. There is a need to create and maintain link-records, while composing, so that when a particular instance of data is revised, so are, some or all, other instances.

Often one finds writing to be a chore due to frequent revisions. There is a need for a paste-link method that automates the revision process and minimizes the number of errors made, while revising, so that users can enjoy the creative aspects of writing.

A common and frequent difficulty encountered while performing computations on a calculator is knowing whether the computed result is correct. For example, to compute the total cost of the items one wishes to purchase at a store, he must enter the price of each item into the calculator, multiply it by the quantity of the item, and add the result to the previous sub-total. If he believes that the total is incorrect, he must re-enter all the data, and the intervening operations, and still not be sure that the new result is correct. Thus, there is a need to preserve the user-entries in the calculator so that the they can be easily reviewed and only those that are incorrect can be revised and the new results automatically re-computed, re-saved, and re-displayed on the device's screen.

For over a decade the government has mandated schools to integrate the reading, writing and the math curriculums. Thus, there is a need for a device that permits students to receive word problems into their devices, which they can read, and then construct mathematical expressions and models to solve the problems and to explain their methodology and the results by writing intervening text expressions.

Students have been learning math in schools without understanding the context in which the mathematical rules are applied or understanding when to use a particular function, like the ‘logarithm’. For example, most schools don't teach kids that an exponentially increasing (or decreasing) sequence of numbers can be transformed into a linear sequence by computing their logarithms. With linear data, the growth-rate (or the decay-rate) is easy to calculate. There is a need for a devise and a method which permits students to easily manipulate data by transforming it, using various functions, and to display the results in an easy-to-interpret format.

There are several reasons why students score low on tests: 1) Sometimes, the problems given to them are ambiguous. Ambiguity can be resolved if a student explains, in writing, how he solved the problem. 2) At other times, students may not understand a mathematical or a scientific concept or the context of the problem. If the teacher can see the model developed by a student and his analysis she can better guide him. 3) It's possible that the student understands the concept and applies it correctly but a ‘silly’ mistake resulted in an incorrect answer. Ordinarily, the teacher would not know the reason for the incorrect result. There is a need for a device and a method that permits her to review the student's work, to fix the mistake, and check whether the automatically re-computed result is correct. She can then grade and guide the student accordingly.

Math-processors (such as MathCAD®, Mathematica® and Maple®) are applications that run on computers and require hi-end operating systems like Windows® or the Mac-OS®. They require lots of disk space and memory and a large, high quality screen. They are intimidating and not for use in elementary or middle schools or by the ordinary user. They perform advanced mathematical tasks, but they do not perform the linking and automatic updating functions.

Rules to write even the simplest expression in these applications are highly evolved. For example, users may be required to use a colon or a semicolon after typing an expression in order to convey to the processor that it is a mathematical expression. To learn the idiosyncrasies of each application, one must read the scary manual or take a course on how to use the application. These applications are designed for engineers and scientists who are willing to learn the complex rules to solve complex problems.

The rules for using math-processors are complex because the applications provide flexibility, power and versatility. It is not wise for ordinary users to spend funds buying a math-processing application even if they can make a wise choice of which application to purchase. Users must spend lots of time researching the choices, installing the selected application onto his computer, learning the complex rules associated with using the application, without feeling overwhelmed by the Greek symbols, and then using only 5% of its capability.

Hardware platforms that execute spreadsheets and math applications can cost $1000 or more and the applications and operating systems are costly too. Using old software or used hardware requires even greater skill. The older tools often do not come with warranties or manuals. Manufacturers and publishers, if they still exist, often do not support their old products.

Advanced calculators—namely, scientific, programming and graphing calculators—have expensive co-processors, whereas, the invention described here relies on a simple micro-processor. Advance calculators are designed with electronics and microcode that execute complex algorithms whereas the inventive device uses a simple editor configured to parse alphanumeric expressions and perform computations in a word-processing-like environment.

Advanced calculators have complicated, densely populated, colorful keypads with multiple legends and sometimes they even require removable key-templates. Each key performs multiple tasks depending on the mode in which the calculator is set to operate, or the sequence in which the key is pressed, or whether the key is pressed in conjunction with another key. The rules and methods to perform calculations on scientific and graphing calculators are complex. These devices are mostly used by engineers and the mathematically sophisticated individuals who need a pocket-size, high-powered computational tool. The entire process of writing and executing a program-file on a calculator is prone to errors, cumbersome, non-intuitive and time-consuming because the calculator-keys are not designed for typing text, the screens are tiny and calculators do not have a well-developed editor. But most importantly, calculators do not interactively parse entire files, with multiple expressions, to compute the results and display them in real-time. Some advanced calculators do parse expressions—one at a time—each upon the user's command—to compute the corresponding result and display it next to the parsed expression. Programmable calculators process data-files in batch mode and then process the executable code in batch mode.

Importantly, in advanced calculators, in spreadsheets, and in math-processors, each expression is revised manually, one-at-a-time, because the expressions are not linked. In the interactive mode, after an expression is revised, it is processed separately and each result is updated one-at-a-time.

The prior art, mentioned above, perform several tasks described here but they are either expensive, or not easy to use, or they are not intuitive. They do not implement the paste-link methods proposed here. Their interfaces are not simple—they are designed for rigorous analysis. The software applications execute only on expensive computers which require high level operating systems, advanced computer skills and are used mostly by the mathematically and technically gifted.

In summary, there is a need for a simple, low-cost, portable device and a method that lets the user create, edit and save his work in a file; where the data is automatically linked and updated when any expression in the file is revised; where text can be inserted between mathematical and graphic expressions; where results are automatically computed, after revisions are made, if the expressions are mathematical; where the memory is automatically updated; and, where all modifications, including the results, are automatically displayed.

### SUMMARY OF THE INVENTION

The invention provides a simple, low-cost, portable word-processing-like environment to perform mathematical computations and basic programming tasks. This is particularly useful for school-age children or for those who write reports and require simple computational tools. The invention permits users to type and save mathematical expressions (or program instructions) into a file so that the instructions can be easily revised later, without having to re-type them, in their entirety, and to have the results automatically re-computed and displayed interactively.

The ordinary user—for example, a student—performs computations on a calculator (not conducive for writing text) and writes term-papers on a computer (not for doing simple arithmetic). He performs calculations on a calculator and types the results into his text document. He uses two devices: a low-cost calculator and an expensive computer and is not able to integrate word processing with calculating. It is an object of the present invention to provide a simple, low-cost, portable, word-processing-like environment (which the user is likely to be familiar with) to compose reports and research papers that integrates writing and computing and performs revisions efficiently and interactively.

A further object of the invention is to provide an input means, preferably a laptop-sized QWERTY keyboard, to permit the user to easily type text, as he would in a word-processor, while performing mathematical tasks and writing reports.

A further object of the invention is to provide an easy editing means, via a well-developed, simple, familiar editor which has cut-copy-paste, find-replace and spell-check features, to permit a user to enter and revise expressions as he would in a word processor.

A further object of the invention is to provide a user with a well-developed file management system which creates, maintains and deletes files, in which a user can enter expressions for processing and revising when desired.

A further object of the invention is to improve the method for revising documents that reduces the time and effort spent and the number of errors made.

A further object of the invention is to organize information contained in a file, or in several files, in a manner that is convenient to locate and revise.

A further object of the invention is to automatically update, re-execute user-instructions, and re-compute the results of mathematical expressions and to display them on-screen.

Another object of the invention is to solve complex problems by first solving simple ones, represented by each mathematical expression, and linking the expressions to compute the grand-result to the complex problem.

Another object of the invention is to permit a user to write text narratives, between mathematical expressions, so that he may write his methodology, thoughts and analysis or provide explanations to a reader. The user feels empowered and learns proper methods for solving problems and discovers new concepts while experimenting, via trail and error, on the device.

Another object of the invention is to permit a user to develop models to simulate results under various scenarios. For example, he can copy his first model to a another file and revise the input values, or the assumptions, to generate alternate results. He can, thus, answer his own questions and perform ‘what-if’ analysis.

Another object of the invention is to permit a user to learn and improve his math skills by setting the device to a mode where it does not display the results for mathematical expressions but, instead, checks whether the user-provided results are correct (or incorrect) and displays the appropriate response on-screen. Thus, he is offered additional opportunities to mentally re-calculate another result and type it next to the expression and command the device verify it.

Another object of the invention is to permit a teacher to examine a student's work, to identify mistakes, and to encourage him to correct the mistakes, in a convenient way, so that it enhances learning and makes grading more accurate.

Another object of the invention is to learn basic programming skills by providing a game-like environment which permits a user to type instructions and generate entertaining (fun) output on-screen.

Another object of the invention is to provide an environment in which students can learn mathematical concepts, functions, operations and rules by using them in alternate ways and examining the results automatically computed by the device.

Another object of the invention is to permit a user to maintain and manipulate personal and financial data in order to improve his welfare.

Another object of the invention is to permit a user to print files, which contain text, data, assumptions, mathematical expressions and the corresponding results so that the work can be reviewed and graded.

Another object of the invention is to permit a user to receive files from other devices for further processing on his inventive device. Thus, a teacher can create a partial model on a computer, or on another inventive device, and transmit it to a student so that he may complete the model.

Another object of the invention is to permit a user to transmit files to other more powerful devices for further processing. For example, he can create a model on the inventive device and send it to a computer that can run a powerful math processing application. He can enhance the model on the computer and generate results for the more advanced mathematical expressions not solvable on the inventive device. Since computers are often shared by several users, in a school, no user has sufficient computer-access.

Another object of the invention is to minimize user-errors and the laborious data-entry tasks and automate revisions, via the paste-link method. As such, results to the mathematical expressions are correct more often.

### BRIEF DESCRIPTION OF THE DRAWINGS

FIG. 1 shows hardware elements of the computing device of the present invention;

FIG. 2 shows elements of the program-memory;

FIG. 3 shows various file commands that are available to the user; and

FIG. 4. Shows a procedure for selecting the operating mode and the result-display format.

### DETAILED DESCRIPTION OF A PREFERRED EMBODIMENT

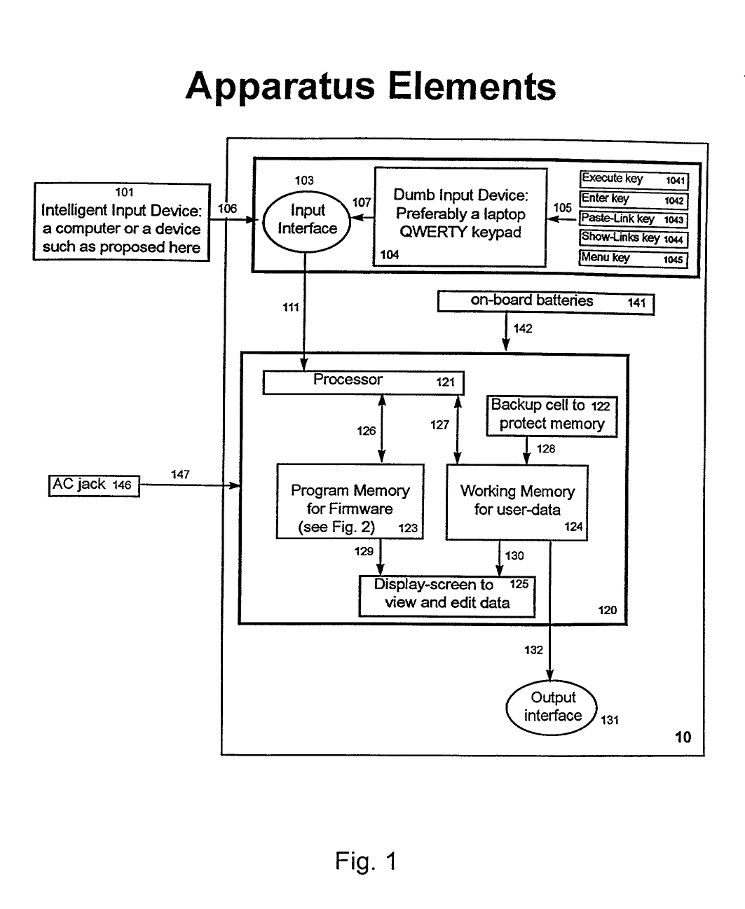

FIG. 1 shows hardware elements of the computing device of the present invention. The device includes a full-sized QWERTY keypad (as the ones used in laptops) (104) and a screen (125) that is larger than the ones in calculators.

The device (10) is powered by the on-board batteries (141), connected to the motherboard (120), via (142), or by AC power (146), connected via (147). Optionally, the device may draw power from another intelligent device (101), such as a computer or a printer, when connected via (106 or 132), to conserve the on-board power supply. When the said power sources are deplete, the working-memory (124), is protected by a backup cell (122), via (128). The device (10) may draw power from the external sources (146, 132 or 101), when connected, in any operating mode—local (403) or communication (402).

The keypad (104) has keys that are commonly available on QWERTY keyboards. A set of dedicated keys (1041-1045), which execute pre-coded instructions when pressed, are connected to the keypad via (105). The keypad is connected to the input-interface (103) via (107). An external intelligent device (101) can send data to the inventive device (10) either via a cable (106), that attaches to the input-interface (103), or transmit data wirelessly, via the input-interface (103).

The input-interface (103) is connected to the device's motherboard (120) via (111). The processor (121) frequently scans the input-interface (103) for data. It accepts the input and deciphers whether it is an instruction or data. If it is an instruction, the processor interprets it using the instruction-code in the program-memory (123) and executes it. The processor's action is displayed on the screen (123), via (135).

If the user-input is data-input, the processor (121) accesses procedures in the program-memory (123), via (126), to store it into the working-memory (124), via (127), and displays it on the screen (125), using the editor (221), embedded in the program-memory (123), via connection (135).

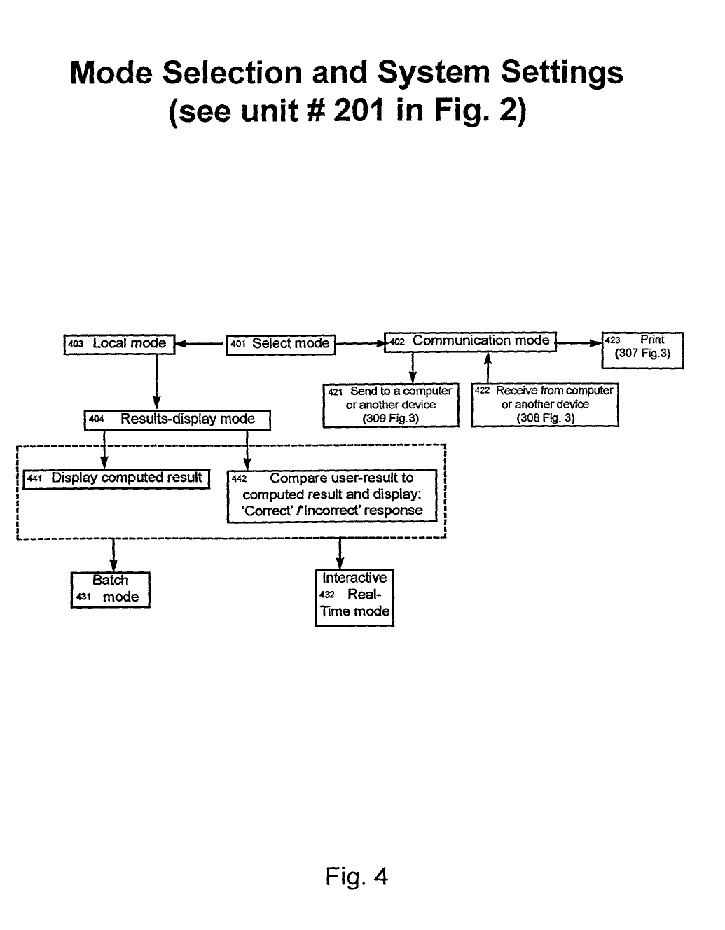

In the communication mode (402, FIG. 4), the processor (121) accepts input from the keypad (104), via (111), and interprets it as an instruction and executes it. The instruction is either:

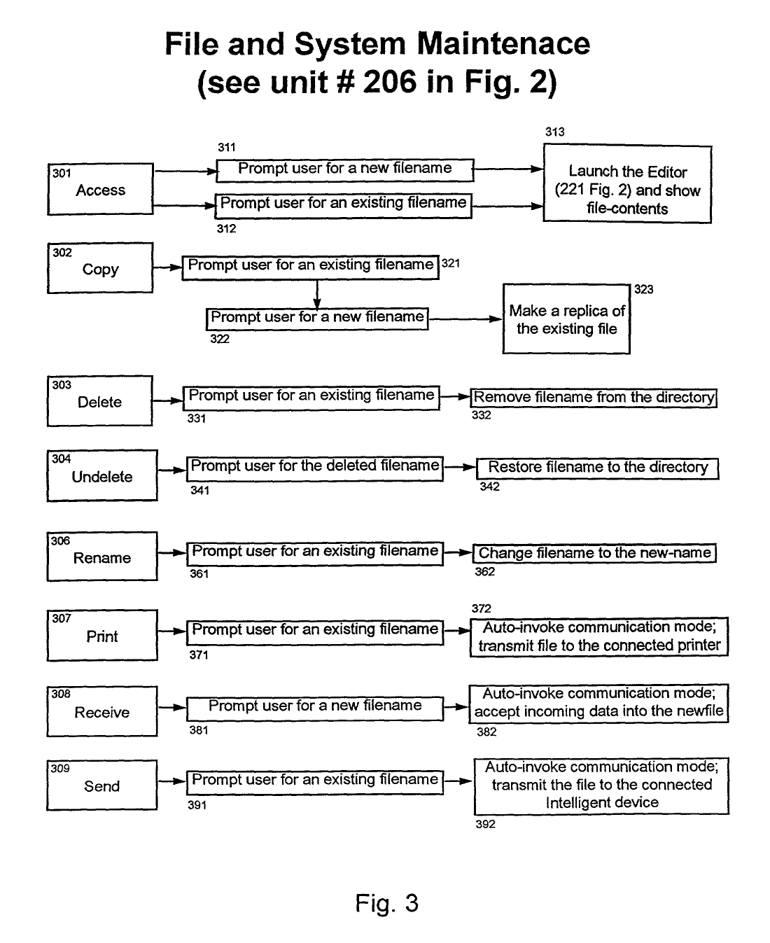

a) to accept input from another intelligent device (101), via the input-interface (103) and cable (111), using the receive-procedure (308, FIG. 3) and store the received data into the working-memory (124), via (127), or

b) send information, stored in the working-memory (124), to another device, using the send-procedure (309) or the print-procedure (307), via the output-interface (131) and the connection (132) or transmit information wirelessly.

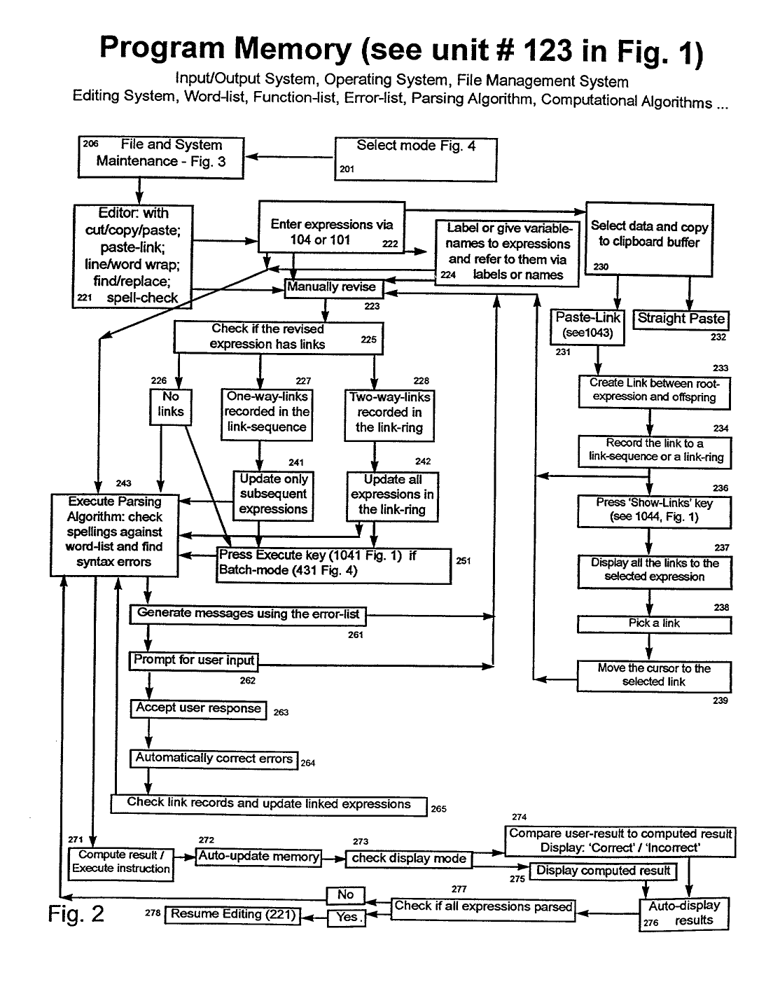

FIG. 2 shows the elements of the program-memory (123)—namely:

a) the code for the user-interface (illustrated in the fifteen examples provided below in this document) which is displayed on the screen (125) via (135);

b) the file-management system (FIG. 3) and the procedures for selecting the operating mode and the system settings (FIG. 4) are also displayed on the screen (125), via connection (135);

c) the data-library which comprises: a word-list for spell-check; an error-list (suggestions to resolve syntax-errors discovered in user-composed expressions or user-instructions); and, Function-names and algorithms to compute Function-values with user-provided input-values;

and, d) the editor (221) comprising: entering and revising expressions (222-242); paste-link methods (231, 233-237); Find/Replace, Cut/Copy/Paste (230 and 232), word-wrap, spell-check, etc.; the parsing algorithm (243); generating correct error-messages and suggestions for users (261); prompting for user-input (262); accepting the user-input (263); automatically revising expressions (264-265); computational algorithms (271); selecting the correct format for displaying results (273-276); and all other obvious procedures not mentioned but necessary to operate the device.

The flow of procedure, drawn in FIG. 2, is described in the section: ‘Description of the Preferred Embodiment of the invention’, below.

FIG. 3 shows the various file commands that are available to the user. He can:

1. Access (301) a new-file by providing a filename when the processor (121) prompts the user for a name (311). The processor then launches the editor (313 or 221 in FIG. 2) with a blank document in which the user may begin entering expressions and data. The processor automatically stores the data entered, one keystroke at a time, by the user in the working-memory (124).

2. Access (301) an existing file by providing a filename (312), or selecting it from the directory of available filenames, when the processor (121) prompts him. The processor then launches the editor (313 or 221 in FIG. 2) and displays the data already stored in the memory and assigned to the selected filename. The user may revise or add or delete information in the file.

3. Copy (302) a file and revise the replica-copy. The processor (121) prompts the user for the filename (321) to be copied. The user supplies the filename. The processor accepts it and then prompts the user for a new filename (322) to be assigned to the replica-copy. After the user supplies the new filename, a replica is created (323) and assigned the new filename.

4. Delete (303) removes a filename from the directory of filenames available on the device (10). The processor prompts the user to provide the filename (331) that is to be removed. The command does not, however, erase the data in the file. Once the filename is removed (332) from the directory, the space in the working-memory allocated to the removed file is now made available to the other files.

5. Undelete (304) instructs the processor (121) to prompt the user for a filename (341) and to restore the filename removed from the directory back into the directory. After it is restored (342), the processor may not write data, entered into another file, to the same location in the working-memory (124) which is allocated to the restored file. After a filename is restored some of its previous contents may no longer be available because the area of the memory which had contained the data may now have been re-assigned to other files.

6. Rename (305) instructs the processor (121) to prompt the user for an existing filename (361) whose name is to be changed. The process processor accepts the new filename and swaps it with the old one (362).

7. Print (307) instructs the processor (121) to prompt the user for an existing filename (371). The processor then automatically invokes the communication mode (402 and 423, FIG. 4) and transmits a copy of the desired file, from the working memory (124), to the output-interface (131), via a cable (132), or wirelessly to the connected printer.

8. Receive (308) instructs the processor (121) to prompt the user for an existing filename (381). The processor then automatically invokes the communication mode (402 and 422, FIG. 4) and receives data, via the input-interface (103), connected with a cable (106), or connected wirelessly, and stores the received data, via (111 and 127) into the working-memory (124) in the space that is allocated to the user-provided filename.

9. Send (309) instructs the processor (121) to prompt the user for an existing filename (391). The processor then automatically invokes the communication mode (402 and 421, FIG. 4) and transmits a copy of the desired file, from the working memory (124), to the output-interface (131), via a cable (132), or wirelessly to the connected to another device—like, a computer, another intelligent device which is preferably another present inventive device (10).

FIG. 4. Shows the procedure for selecting the operating mode and the result-display format. The device can be operated in the following modes:

1) Local mode (403) comprising either:

a) Real-time (Interactive) execution (432)

b) Batch (Background) execution (431)

2) Results-display-mode (434)—processor (121, FIG. 1) displays:

a) The computed result (275, FIG. 2) to a mathematical expression.

b) ‘CORRECT’/‘INCORRECT’ response (274, FIG. 2) by comparing the user-provided result to the computed result.

3) Communication mode (402)—files may be:

a) sent from the inventive device to another device—like a printer (307, FIG. 3), a computer, or another inventive device (309, FIG. 3).

b) received from another intelligent device for revision and for local processing on the inventive device (308, FIG. 3). The user must select an existing file-name, in the working-memory (124), to transmit or provide a new-filename to receive and store incoming data. Procedure (206, 371, 381, or 391) to select a filename, or to name a new-file, is embedded in the program-memory (123) and described in detail in FIG. 3 description above.

In the local mode (403), data entered into the device can be examined on the display (125) and the user-created files, maintained in storage (124), are processed by the device's processor (121). Execution occurs interactively (432) if the expression is processed as soon as the ‘Enter’ key (1042) is pressed, at the end of the expression, or if the cursor is moved out of the expression's range (conveying to the processor that the expression is complete), or if another key (for example, the ‘Execute’ key (1041)), on the input means (104), is pressed.

In the interactive mode, the revised expression, and all other expressions that are affected by the revision, are updated and their corresponding results are automatically re-computed, saved and displayed on the screen.

Alternately, user-files can be processed, later, in batch mode (431), whereby the ‘Enter’ keystroke (1042) typed at the end of an expression, while the file is edited (221), is stored and processed after the ‘Execute’ key (1041) is pressed or if the device is switched to the interactive (432) mode.

The present invention can be used in schools. Students and teachers can examine the work product - not just the results. If an expression is revised, its recurrences are automatically updated and the results of the mathematical expressions are ‘interactively’ re-computed in ‘real-time’.

Another way of implicitly instructing the device to process the revised expression (or the expression most recently entered), in real-time, is by moving the cursor out of the expression's range. If it is referred to in a subsequent expression then that expression too is automatically updated and its result is re-computed (271, FIG. 2) and displayed on the screen (125, FIG. 1 and 273, FIG. 2).

By using the paste-link method, while composing a file, a user can later easily correct a mistake, if it occurs at multiple locations, in a one-shot manner because the paste-link method creates a record of the multiple instances of the data. The present invention proposes three techniques for paste-linking data.

a) The ‘straight-link’ technique creates a link between the root-data and the pasted-data and records their locations into an ordered link-sequence file which is stored in memory (124). The user may, later, select a particular instance of the data, root or pasted, for examination. The link-sequence is an ordered record that shows the chronological sequence of each instance of the data. When the user revises a particular instance, none of the other instances change.

b) The ‘one-way-link’ technique also creates links between the root-data and pasted-data and records their locations into an ordered link-sequence file which is stored in memory (124). The user may, later, select a particular instance of the data and revise it. In doing so, only the chronological subsequent instances are automatically modified—none of the previous instances are affected.

c) The ‘two-way-link’ technique also creates links between the root-data and pasted-data and records their locations into an unordered link-ring which is stored in memory (124). A link-ring is not a sequential record and does not track which instance is the original root-data nor does it track the order in which each instance is pasted. The user may, later, select any instance of the data and revise it—causing all linked instances to be automatically modified.

A user may, however, not want all instances modified. Thus, the paste-link methods may not always be desirable and, therefore, can be used optionally. In such a case, the user employs the straight-paste method (already available in most software applications) and later uses the Find-Replace method to selectively modify some of the instances of the data.

If the paste-link methods are implemented on a low-cost portable device, storage cost is not cheap. RAM costs significantly more than the magnetic hard disks. Thus, storage must be used wisely by creating compact link-records.

One implementation of the paste-link method is as follows. User selects certain data and copies it to the clipboard (which is also part of the memory). He then moves the cursor to another location, in the same file, or another file, and presses the ‘Ctrl’ and the ‘L’ keys, simultaneously, or a pre-programmed ‘Paste-link’ key (1043 in FIG. 1) if the device has it, or selects the paste-link option from a menu. In any implementation, data from the clipboard is pasted at the cursor's present location and the link-record captures and records the locations of the root-data and the pasted-data. Different combomation keys (or pre-programmed keys) are used for each paste-link method. Alternatively, if the same key is used, a menu of choices is served on the device-screen from which the user can select the desired paste-link method.

If a user presses the ‘Show-links’ key (1044, FIG. 1), the processor (121, FIG. 1) extracts the link-record, associated with the data where the cursor is located, if it has a link-record, and displays it in a menu-form on the screen (125, FIG. 1). The user may then select one of the linked instances which commands the processor to locate the linked instance and to move the cursor to the desired instance.

The flow of procedure, drawn in FIG. 2, is described in detail below:

1. A user first selects the operating mode (201, FIG. 2 or 401, FIG. 4). He either selects the communication mode (402, FIG. 4) or the local mode (403, FIG. 4)

2. If he selects the local mode, he then selects the results-display mode (404).

3. He then selects either the Batch mode (431) or the Interactive (Real-time) mode (432).

4. He then accesses the file-management system (206) (see FIG. 3 and the detailed description of FIG. 3 below). He accesses (301, FIG. 3) a file by either instructing the processor to open an existing file (312, FIG. 3) or create a new-file and provides a file-name (331, FIG. 3).

5. The processor (121) then launches the editor (221, also 313, FIG. 3). The processor displays the contents of the desired file on the screen (125). If the file is new, it has no contents and so is the screen is blank.

6. The user then enters new expressions (222), via the input means (104) or manually revises existing expressions (223) also via the input means (104).

7. If he is entering new expressions, he may either: a) label an expression and refer to it in other expressions, or b) associate an expression with a variable-name and refer to it, via the name, in other expressions, or c) he select an expression and copy it (230) to the clipboard-memory and then paste it to another location in the same file or in another file.

8. He may either paste the data with the straight-paste method (232), which is commonly used in most editors and word-processors, and does not create any link-records, or he may paste the selected data with the inventive paste-link method (231, 233-237) which have been described in detail above.

9. The user may continue entering more expressions or revising existing ones. If he is revising expressions, the processor (121) checks whether a revised expression is linked to other expressions. If it is, the processor then checks whether the links are one-way-links (227) or two-way-links (228). The processor then automatically revises the appropriate linked expressions as described above.

10. If the device (10) is operating in batch mode (431), the processor (121) does not parse any expression in the active document until the user explicitly issues the ‘Execute’ instruction by pressing the dedicated key (1041). If, however, the device is operating in interactive mode (432), the processor commences parsing (243) the most recently entered expression, as described above, and updates the results for all the expressions that are affected by the revision.

11. While parsing an expression (243), if the processor (121) encounters syntax-errors, optionally, it generates messages and suggestions (261) for the user to resolve the errors and to correct them.

12. The user may exit from the parsing procedure by pressing ‘Esc’ on the input keypad (104) and then manually revise the expression (223).

13. Optionally,, the processor prompts the user for input (262), to resolve the syntax-error. In such a case, the user may either provide input to the processor (263) or press the ‘Esc’ key on the input keypad (104) to exit from the automatic error-resolving procedure and, instead, to resolve the error manually via (223).

14. If the user responds to the prompt (262), the processor accepts the user-input (263) and automatically revises the erroneous expression (264) and then checks whether other expressions, linked to the revised expression, need to be revised and updated (265).

15. The processor (121) repeats steps 10-14. When all syntax errors for the expression are resolved, the processor computes the result, for the mathematical expression, or executes the instruction (271).

16. The processor (121) then updates (272) the memory (124), and checks the result-display mode setting (273 or 404 in FIG. 4).

17. The processor (121) displays either the computed result (275) or compares the user-provided result to the computed result (274) and displays a response of ‘Correct’/‘Incorrect’ on the screen (125).

18. The processor (121) then automatically updates the results of all other mathematical expressions affected by the parsed and processed expression and automatically displays the corresponding results (276).

19. The processor (121) then checks (277) if all the expressions in the active file have been processed. If so, parsing and processing halt and the control is transferred to the user. If, on the other hand, not all expressions have been processed, the processor proceeds to parsing the next expression (243), in the file, and steps 10-19 are repeated.

20. The user may resume editing, in which case, steps 6-19 are repeated, or if the he is finished, he may press the ‘Esc’ key to exit from the document and return to step 1, 2, 3 or 4.

The elements of the low-cost portable device (FIG. 1) include:

on-board power means (141) or a connecting means to draw AC power (142);

input means (104)—preferably a QWERTY keypad used in laptops—to enter information and issue commands with dedicated keys (like, 1041-1044);

input interface (103) means to receive data from other devices (101);

storage means (123) for the firmware comprising the operating system, a file system (FIG. 3), resident-programs, algorithms and a data-library;

storage means (124) to record user-created files, link-records, clipboard contents, and files received from other devices (101);

display means (125) to view and revise, via the editor (221), the contents of the storage means (124);

processor means (121) to control all the other elements;

means to select the operating mode (401-442);

output interface (131) means to send data to other devices.

The improvement in hardware, over the prior art are the input means for easy entry of text and long mathematical expressions and a larger screen. The software features and the user-interface, stated below, comprise the remaining improvements over the prior art. The resident-program (123) comprises the: editor (221); paste-link method (230-239); parser (243); syntax-error generator (261-265); and, the computing algorithm (271).

file management system which maintains multiple files (206 or FIG. 2);

intuitive user-interface (123 and 125)—i.e., ‘what-is-typed’ is ‘what-is-seen’ (see examples in the ‘user-interface description’ section for further details);

simple and familiar editing means (221), with cut-copy-paste, find-replace, word-wrap at the end of the screen-line;

optional method to link data (231-234) via one of the proposed link methods;

optional method to display all linked instances of the selected data (236, 237);

optional method to pick one of the instances (238) displayed and to move the cursor to it (239);

optional method to label expressions (224) and refer to them in other expressions;

optional method to assign variable-names for use in other expressions;

optional method to automatically update linked occurrences (241, 242) when one of the linked occurrences is revised (223);

method to parse (243) expressions and to generate syntax-errors (261);

optional method to prompt (262) for user-input;

optional method to accept the user-input (263);

optional method to automatically revise (264) the erroneous expression;

method to automatically re-compute results, for the mathematical expressions, and execute user-instructions (271);

optional method to automatically display all modified expressions (125);

method to automatically display the updated results (273-275) post-revision;

method to automatically save (272) revisions and the updated results;

optional method to permit entering intervening text expressions between mathematical expressions (222);

optional method to generate suggestions (261) to resolve syntax-errors;

optional method to execute user-instructions including conditional statements;

optional method to permit users to supply results to mathematical expressions;

optional method to check user-supplied results and respond with ‘Correct’ or ‘Incorrect’ so that he may supply another result (404, 441, 442);

optional method to pause processing at any point in the file so that the user may examine the preliminary results, edit the file, if necessary, and command the processor to resume processing by pressing the ‘Execute’ key (1041);

optional method to receive data from a computer or a device such as the inventive device (101, 308, 422);

optional method to print files (423, 307) with or without the results;

optional method to send files (131, 309, 421) to other devices;

optional keys (1041-1044) which, when pressed, instruct the processor (121) to perform pre-coded tasks;

method to process information interactively (432) or in batch mode (431);

optional method to receive (100, 308, 422) and automatically upgrade the device's resident-programs or its data-library (123 or FIG. 2).

### NOVELTIES OF THE INVENTION

1) Low-cost relative to a laptop—10 percent the cost of an average laptop.

2) More power-efficient than a laptop.

3) More durable than a laptop.

4) Full-sized QWERTY keypad for easy text entry—unlike those on a calculator.

5) Full-featured, editor which performs word-wrap, find/replace and spell-check.

6) Paste-link method for quick and accurate editing and revising.

7) Link-records for organizing data so that it is quickly located.

8) Automatically updating linked expressions.

9) Interactively computing all linked expressions.

10) Automatically updating the memory post-revision.

11) Automatically displaying re-computed results.

12) A well-developed file management system unlike those on calculators.

13) Permitting intervening text between mathematical expressions.

14) Generating syntax-errors with suggestions to resolve them.

15) Prompting the user for input and applying it to revise all linked expressions then proceeding with computing, updating and automatically displaying the modifications and the new results.

16) Checking user-provided results and responding with either a ‘Correct’/‘Incorrect’ type response or with the computed result for the mathematical expression - depending on user-preference.

In the context of schools, the device can be used for learning, when a user select the mode the appropriate results-display mode for mathematical expressions. He may supply results to the expressions and let the processor (121) compute the result and respond with: ‘Correct’ or ‘Incorrect’ (442) after comparing his result against the computed result. If it responds with ‘Incorrect’, the user may revise his result and press the ‘Execute’ key to command the processor to check his revised result and respond again. Alternately, the result-display mode (404) can be selected so that the device displays the computed result (441) and the user checks whether it matches his own mentally computed result.

In communication mode (402), the device either sends (131, 309, 421) a file from the storage (124) to other devices or receives (101, 422, 308) files for further processing (243-274) on the inventive device in the local mode (403).

### DESCRIPTION OF THE USER-INTERFACE AND THE PARSER (243)

The user first selects a resident-program (123)—from a menu of variety of applications on the device. He confirms the selection, by pressing the ‘Enter’ key (1042), which loads the requested application into the processor (121). If he launches the math-processor, he then selects the mode of operation (201, 401).

Local mode (403):

A) Real-time (Interactive) mode (432)

B) Batch mode (431)

Result-Display Mode (404)

A) The user provides a result of a mathematical expression and the processor responds with a ‘Correct’/‘Incorrect’ (442) type response

b) Actual computed result (441)

Communication mode (402):

A) Send (131, 309, 421)

B) Receive (101, 103, 308, 422)

C) Print (131, 423, 307)

The processor (121) prompts for a filename (FIG. 3). After it is typed, via the input means (104), a new file, or an existing file, is presented on the screen (125) for data-entry or revision (313, 221). The user may type text or mathematical expressions or programming statements. Expressions may have several elements—data and operators—like: addition, subtraction, division or multiplication.

### EXAMPLE 1 1000+2000+3000+4000−6000−2000+400000+250000

An expression may require several lines which can be viewed on the screen. Lines wrap automatically at the screen's right-edge and preserving words (not chopping them arbitrarily while wrapping lines). They wrap forward or backward as data is added or deleted from expressions. If the device is in interactive mode, the most recently entered (or revised) expression is processed when the ‘Enter’ key (1042) is pressed, which is displayed on the screen as ‘ [symbol] ’, at the end of an expression.

Results may be displayed to the right or the left of the corresponding expressions. In the illustrations below, the results are displayed to the right. When ‘ [symbol] ’ (1042) is pressed, the device computes the result ‘652000’ and displays it in the result-field.

1000+2000+3000+4000−6000−2000⇄400000+250000 [symbol] 652000

### EXAMPLE 2

A more complex expression is:

−1+2*(3+2)−[2+4]/2+2

[symbol]

First, (3+2) is evaluated (equaling 5); then [2+4] is evaluated (equaling 6). Next, −1 is recognized as a negative number; then 2*(5) and [6]/2 are evaluated to equal 10 and 3, respectively. Finally, −1+10−3+2 is evaluated to produce a result of 8. Thus, the screen displays:

−1+2*(3+2)−[2+4]/2+2 [symbol] 8

### EXAMPLE 3

Users may also type logical expressions, like: 3>2

When [symbol] is pressed, the screen displays:

3>2 [symbol] TRUE

In the device's memory, however, ‘TRUE’ and ‘Correct’ results are recorded as ‘1’ whereas as ‘FALSE’ and ‘Incorrect’ results are recorded as ‘0’.

### EXAMPLE 4

To appreciate a more complex example, switch the device to batch mode so that multiple expressions can be typed, each terminating with [symbol] , without the processor parsing the expressions until the entire example is entered and after the ‘Execute’ key is pressed

A=3

[symbol]

B=6

[symbol]

365*A+600/B<1000

[symbol]

In the example, the third expression is linked to the first two via the variable-name method. The first two expressions assign variable-names, A and B, to the data, 3 and 6, respectively. When ‘Execute’ is pressed, the processor parses the expressions and computes the results for each and displays them as follows:

| | |
|---|---|
| A = 3 [symbol] | 3 |
| B = 6 [symbol] | 6 |
| 365*A + 600/B < 1000 [symbol] | FALSE |

### EXAMPLE 5

An expression may be an instruction to the processor or a text comment and thus may not yield an alphanumeric result. The device permits a user to build a model that performs a simulation (i.e., a ‘what-if-scenario’) with conditional execution—i.e., with ‘IF’ statements—and provide loops around expressions that need to be re-computed or re-executed several times, perhaps with different values each time, until certain conditions manifest. Thus, instead of typing the same set of expressions, repeatedly, the user can create computational loops by applying ‘GoTo’ statements which instruct the processor to branch to expressions preceding the current expression and to process the intervening expressions. Result of the conditional statement, at each iteration through the loop, determines the number of loop-iterations that are performed.

Any expression can be labeled and referred to in other expressions. Thus, below, L1 is a label tagged to the 3rd expression which is referred to in the 5th expression.

A=0

[symbol]

B=10

[symbol]

L1; A=A+10

[symbol]

C=A*B+100

[symbol]

GoTo L1

[symbol]

Note: even though there are no syntax errors in the above example, there is a flaw in the model. When the ‘Execute’ key is pressed, the computing algorithm (123, 271) is caught in an infinite loop, due to the GoTo instruction, causing the values of A and C to explode. Execution halts when the values become very large. At that stage, the device displays:

| | |
|---|---|
| A = 0 [symbol] | 0 |
| B = 10 [symbol] | 10 |
| L1; A = A + B [symbol] | OVERFLOW |
| C = A * B + 100 [symbol] | OVERFLOW |
| GoTo L1 [symbol] | OK? |

‘OVERFLOW’ implies that the result exceeds the processor capacity. To resolve the flaw, the model must be revised but not entirely re-typed since it is saved in storage (124). The user simply moves the cursor to the appropriate location and edits the expression. The next example illustrates one method for resolving for resolving the flaw.

### EXAMPLE 6

Optionally, the device performs ‘conditional’ execution. Expressions may be compound expressions—i.e., an instruction may follow a logical conditional statement which commands the processor to first check ‘IF (a>b)’ and, only if ‘TRUE’, execute the instruction that follows the logical statement. The following corrects the flaw in Example 5 above.

A=0

[symbol]

B=10

[symbol]

L1; A=A+B

[symbol]

C=A*B+100

[symbol]

IF (C<1000) GoTo L1

[symbol]

When the ‘Execute’ key is pressed, the display reads:

| | |
|---|---|
| A = 0 [symbol] | 0 |
| B = 10 [symbol] | 10 |
| L1; A = A + B [symbol] | 90 |
| C = A * B + 100 [symbol] | 1000 |
| IF (C < 1000) GoTo L1 [symbol] | FALSE |

The results for the 3rd and the 4th expressions start at 10 and 200, respectively, then quickly rise to 90 and 1000. The result for the 5th expression starts with ‘TRUE’ (because the value of C is, at first, less than 1000) quickly followed by ‘OK’ (in response to ‘GoTo L1’). The result for the 5th expression rapidly oscillates between ‘TRUE’ and ‘OK’, nine times, before finally halting to ‘FALSE’, at the 10th iteration of the loop. At the final iteration, C is 1000 and the condition ‘IF (C<1000)’ becomes ‘FALSE’ and the processor does not branch to L1. Instead, it proceeds to the next statement, if there is one, or stops processing if the entire file is processed.

### EXAMPLE 7

Math expressions and instructions may include Functions like: sine, logarithm, square-root, etc. Functions can be invoked via dedicated keys on the input means, or by directly typing the Function-name, or by invoking a menu of function-names from which the desired Function is selected.

In the interactive mode, the device parses expressions for syntax-errors. Like the spell-checker, the parser scans each expression to check if it's spelt correctly and provides suggestions if it's not. Specifically, the parser checks the spellings of Function-names and variable-names and also checks the manner in which the Functions are constructed. It checks the entire expression like the grammar-check, in most word processors, evaluates sentences and paragraphs. Thus, if a Function is misspelled, or if the number of right an left parentheses are unbalanced, or if there is an extra decimal point, or if data or an operator is missing, the parser identifies such errors and, if it can, provides suggestions to resolve the errors, one-at-a-time, by moving the cursor from left to right.

L1A=sine(90)

The parser scans the above expression and stops after scanning L1. It can't decipher whether L1 is a variable-name or a label. Thus, it alerts the user by responding: ‘L1 UNDFND’, in the result-field, and displays “L1=” on the prompt line. The screen shows:

| | |
|---|---|
| L1 A = sine(90) [symbol] | L1 UNDFND |
| “L1 =” | |

The user may type an alphanumeric value for L1 (if it is a variable-name) or press a key, for example, the ‘Esc’ key, to exit from the parsing procedure and edit the expression. In the above expression, L1 is a label. If it were a variable-name, an operator would be required between L1 and A and L1 would have been previously defined. In such a case, the user would exit from the parsing algorithm; create an expression that assigns a value to L1 and edit the above erroneous expression by providing an operator between L1 and A. However, since L1 is a label, the user presses ‘Esc’ when he is prompted for an input value. The prompt line “L1=” disappears and the cursor appears after L1. He then types a semi-colon ‘;’ to denote that L1 is a label. The expression now reads:

L1; A=sine(90) [symbol] L1 UNDFND

Pressing the ‘Execute’ key resumes parsing and the screen displays:

L1; A=sine(90) [symbol] SINE?

The processor informs the user, in the result-field, that there is a syntax-error—i.e., ‘SINE’ is not recognized. The processor may generate a helpful suggestion by displaying ‘SIN’ on the prompt line or in the result-field. The user may either accept the processor's suggestion by pressing the ‘Enter’ key to confirm or he may press the ‘Esc’ key to exit from the procedure and directly revise the word ‘sine’ to ‘sin’ and press then the ‘Execute’ key. The revised expression is parsed again. Since no errors remain, the result is computed and displayed:

L1; A=sin(90) [symbol] 1

The result displayed in the result-field is ‘1’ because sin(90)=1. Of course, the user may select the mode so that the input provided for the trigonometric functions is interpreted by the processor either as degrees or as radians.

### EXAMPLE 8

To revise a file, the user issues the ‘OPEN’ command and types a file-name. The processor displays its contents, including the computed results. Consider the following model.

| | |
|---|---|
| A = 0 [symbol] | 0 |
| B = 10 [symbol] | 10 |
| L1; A = A + B [symbol] | 90 |
| C = A * B + 100 [symbol] | 1000 |
| IF (C < 1000) GoTo L1 [symbol] | FALSE |

After the file is opened, the user revises the 3rd expression to read L1; A=A+2*B and moves the cursor up or down (to move it out of the expressions range) or presses the ‘Execute’ key. In the interactive mode, the entire file is automatically re-processed and the results of all the expressions that are affected by the revision are automatically re-computed and displayed. The file is parsed, no errors are found, and the last three expressions are re-computed, iteratively. Processing halts when the value of ‘C’ exceeds 1000 at which point the screen shows:

| | |
|---|---|
| A = 0 [symbol] | 0 |
| B = 10 [symbol] | 10 |
| L1; A = A + 2*B [symbol] | 100 |
| C = A * B + 100 [symbol] | 1100 |
| IF (C < 1000) GoTo L1 [symbol] | FALSE |

### UTILITY OF THE INVENTION

### EXAMPLE 9

A learning tool. While the device is in communication mode, a user can receive a file, containing word problems, from a teacher's device. If the problem is too complex to solve with a single mathematical expression, he can solve it with smaller expressions and combine the results to compute the answer to the problem. Consider the following situation.

“On Jan. 1, 2000 John has $10 in his checking account. He finds a job that pays him $100 each month. He begins work on January 2nd. He is paid on the last day of each month and can only deposit his income into the checking account the next day. The bank pays 1% interest, each month, on the amount maintained in the account during the month. Each month he needs $10 to pay for the bus fare to go to work. So, he withdraws $10 from his account to purchase a pass for the first month. Thereafter, he uses $10 from his wages to buy a pass for each month and deposits the rest into his account. During which month does John's account have at least $1000 if he does not spend more than the $10 for the bus fare?”

The student first sets the device to batch mode to concentrate on constructing a model to solve the problem without receiving syntax-error messages and interruptions from the processor. He composes the following expressions:

Balance=10−10

[symbol]

WageIncome=100

[symbol]

IntRate=0.01

[symbol]

Busfare=10

[symbol]

Month=1

[symbol]

Deposit=WageIncome−Busfare

[symbol]

L1; IntIncome=IntRate*Balance

[symbol]

Balance=Balance+IntIncome+Deposit

[symbol]

Month=Month+1

[symbol]

IF (Balance<1000) GoTo L1

[symbol]

He checks his work for errors and then presses the ‘Execute’ key. Processing begins. Since there is a ‘GoTo’ command at the end, the processor branches to L1 and loops through the four expressions several times. Each time, it updates the result for each expression in the loop. The user does not see the results, at each iteration, because the result-fields update rapidly and converge to:

| | |
|---|---|
| Balance = 10 − 10 [symbol] | 0 |
| WageIncome = 100 [symbol] | 100 |
| IntRate = 0.01 [symbol] | 0.01 |
| Busfare = 10 [symbol] | 10 |
| Month = 1 [symbol] | 1 |
| Deposit = WageIncome − Busfare [symbol] | 90 |
| L1; IntIncome = IntRate * Balance [symbol] | 9.42 |
| Balance = Balance + IntIncome + Deposit [symbol] | 1041.02 |
| Month = Month + 1 [symbol] | 12 |
| IF (Balance < 1000) GoTo L1 [symbol] | FALSE |

John observes that since the final value, after eleven iterations, for the variable-name ‘Month’ is 12, it implies that in the twelfth month—i.e., in December 2000—he will have at least $1000 in his account when he deposits the November wages.

### EXAMPLE 10

The device permits a user to test his skills. He may supply a result to an expression. The processor responds whether it is ‘correct’ or ‘incorrect’. If it responds: ‘incorrect’, he may revise the result and press ‘Execute’ for the processor to re-check. Alternately, the device may provide the computed result so that the user can compare it to his own. The response that the processor displays depends on the result-display mode selected. A teacher may beam the following problem to the student:

1000+2000+3000+4000−6000−2000+400000+250000

[symbol]

Suppose he guesses that the answer is ‘653000’ and he types it at the end of the expression, before of [symbol] . The screen shows:

1000+2000+3000+4000−6000−2000+400000+250000=653000

[symbol]

He can now press ‘Execute’ and the processor responds:

| | |
|---|---|
| 1000 + 2000 + 3000 + 4000 − 6000 − | |
| 2000 + 400000 + 250000 = 653000 [symbol] | INCORRECT |

The student can now provide another guess. Suppose he supplies ‘652000’ and presses ‘Execute’. The processor responds and the screen shows:

| | |
|---|---|
| 1000 + 2000 + 3000 + 4000 − 6000 − | |
| 2000 + 400000 + 250000 = 652000 [symbol] | CORRECT |

Optionally, the device may respond: ‘TRY AGAIN’/‘BRAVO’, in the above example.

The device permits the user to print the file so that he may receive feedback from the teacher an d revise the expressions.

### EXAMPLE 11

A tool for writing research papers or lab reports. The device permits the student to explain the methodology used to solve the problem or explain whether the results make sense to him and if there are other ways of solving the problem. He may write text comments (expressions), between the math expressions, into the above example as shown below:

| | |
|---|---|
| Balance = 10 − 10 [symbol] | 0 |
| “John withdraws funds for the busfare” [symbol] | |
| WageIncome = 100 [symbol] | 100 |
| IntRate = 0.02 [symbol] | 0.02 |
| “IntRate = 2% divided by 100” [symbol] | |
| Busfare = 10 [symbol] | 10 |
| Month = 1 [symbol] | 1 |
| “January is Month 1 - John begins work” [symbol] | |
| Deposit = WageIncome − Busfare [symbol] | 90 |
| “He deposits what remains after buying the pass” [symbol] | |
| L1; IntIncome = IntRate * Balance [symbol] | 19.71 |
| Balance = Balance + IntIncome + Deposit [symbol] | 1095.18 |
| “The balance at the beginning of the month equals the | |
| previous balance + the interest earned in the account | |
| plus the deposit made at the beginning of the month” [symbol] | |
| Month = Month + 1 [symbol] | 12 |
| “Increase the value of Month at each iteration of the | |
| loop. The final value of Month, when processing halts, | |
| will be for that month when balance in the account | |
| exceeds 1000 as tested by the next logical condition.” [symbol] | |
| IF (Balance < 1000) GoTo L1 [symbol] | FALSE |
| “In conclusion: If John had borrowed $10 in January for | |
| the bus fare he wouldn't have had to work in November. | |
| The balance in his account would have exceeded $1000 | |
| in end-November after receiving the interest.” [symbol] | |

the bus fare he wouldn't have had to work in November. The balance in his account would have exceeded $1000 in end-November after receiving the interest.”

[symbol]

### EXAMPLE 12

The device can be used for tasks—like, balancing a checkbook. It keeps a record of the withdrawals and deposits and permits the user to print the file, with the results, so that he can later check for mistakes and correct them.

“Checking account activity for June 2000”

| | |
|---|---|
| LastBalance = 3456.09 [symbol] | 3456.09 |
| Deposits = 1000 + 2000 + 300 + 654 + 750 + 1000 + 1000 [symbol] | 6704.00 |
| Withdrawals = 12.98 + 5.99 + 3333.33 + 76.55 + 44.44 [symbol] | 3473.29 |
| NewBalance = LastBalance + Deposits − Withdrawals [symbol] | 6686.80 |

The user can save the above information, in a file named ‘JUNE’, and later revise it. He can also make a file-copy named ‘JULY’; open it and revise the data in it without changing the model. The device automatically updates the results. For example, his revisions could be the following:

### EXAMPLE 13

A personal tool. Imagine a person wishes to keep a count of the calories he consumes each day. He constructs a file, on the device, with variables like: Fish, Meat, Poultry, and other products he consumes and assigns to each product the number of calories it contains per ounce. He may create additional variable-names and set them to equal the quantity of each item he consumes that day. He then creates a mathematical expression that multiplies the caloric content of each product by the quantity consumed and sums the calories consumed from each product to determine the total calories consumed on a particular day.

Once he has constructed the model, all he has to do each day is make a file-copy of the previous day's record, open it, and revise the heading and the quantity of each item consumed. The device automatically computes the total calories consumed that day. The following illustrates the above discussion.

“Caloric Intake Record for Jul. 17, 1999”

[symbol]

| | |
|---|---|
| “# of calories per ounce of product” [symbol] | |
| Fish = 75 [symbol] | 75 |
| Beef = 200 [symbol] | 200 |
| Poultry = 100 [symbol] | 100 |
| Pork = 150 [symbol] | 150 |
| Icecream = 250 [symbol] | 250 |
| “# of ounces consumed of each product item.” | |
| FishOZ = 14 [symbol] | 14 |
| BeefOZ = 8 [symbol] | 8 |
| PoultryOZ = 4 [symbol] | 4 |
| PorkOZ = 0 [symbol] | 0 |
| IcecreamOZ = 4 [symbol] | 4 |
| TotalCals = Fish * FishOZ + Beef * BeefOZ + | 3300 |
| Poultry * PoultryOZ + Pork * PorkOZ + | |
| Icecream * IcecreamOZ [symbol] | |

On Jul. 18, 1999, he makes a file-copy of the previous day's record, the one shown above, and revises it. After the revisions, the file-name Jul. 18, 1999 looks like:

“Caloric Intake Record for Jul. 18, 1999”

[symbol]

| | |
|---|---|
| “# of calories per ounce of product” [symbol] | |
| Fish = 75 [symbol] | 75 |
| Beef = 200 [symbol] | 200 |
| Poultry = 100 [symbol] | 100 |
| Pork = 150 [symbol] | 150 |
| Icecream = 250 [symbol] | 250 |
| Candy = 250 [symbol] | 250 |
| “# of ounces/bars consumed of each product.” [symbol] | |
| FishOZ = 14 [symbol] | 14 |
| BeefOZ = 8 [symbol] | 8 |
| PoultryOZ = 4 [symbol] | 4 |
| PorkOZ = 0 [symbol] | 0 |
| IcecreamOZ = 4 [symbol] | 4 |
| #ofBars = 2 [symbol] | 2 |
| TotalCals = Fish * FishOZ + Beef * BeefOZ + | 3800 |
| Poultry * PoultryOZ + Pork * PorkOZ + | |
| Icecream * IcecreamOZ + Candy * #ofBars [symbol] | |

The device reduces the chore of calculating the caloric intake for each day by building a simple model that performs the computation. The user maintains a separate file, for each day, to track his progress over a certain duration.

### EXAMPLE 14

A simple financial tool. Suppose Tom has an opportunity to invest in two funds offered by his bank. He may not know which fund to select even if he understands the terms of the offer. If he were given the inventive device and taught how to convert the bank's terms offer, into a model, that executes on the device, he could adjust the number of transactions he makes each month, or revise the amounts he deposits and withdraws each month. The device would automatically compute the results, on a compound basis, showing what his investment portfolio would look like at the end of each month.

Suppose plan1 offers 1% interest per month for 12 months and charges a monthly fee of $10. Tom may withdraw or deposit once a month, on the first day of each month, and pay a 1% fee for each withdrawal or deposit. He receives an interest on the amount of funds he maintains in the account for that month.

Plan2 offers no interest for the first four months but pays 2% interest for the following eight months. Funds deposited must be maintained with the bank for one year. No monthly fees are charged.

Suppose Tom has saved $10000 and will save $1000 each month from his wages. Which plan maximizes his wealth at the end of twelve months? To find the answer, he sets the device to batch mode and builds a model for Plan1.

Month=1

[symbol]

Balance=10000

[symbol]

MonthlyFee=10

[symbol]

Deposit=1000

[symbol]

Withdrawal=0

[symbol]

TransXnFee=0.01*(Withdrawal+Deposit)

[symbol]

100; Interest=0.01*Balance

[symbol]

Balance=Balance+Interest+Deposit−Withdrawal−TransXnFee−MonthlyFee

[symbol]

Month=Month+1

[symbol]

IF (Month<12) GoTo 100

[symbol]

He then presses ‘Execute’. The processor iterates through the loop several times and computes the following results.

| | |
|---|---|
| Month = 1 [symbol] | 1 |
| Balance = 10000 [symbol] | 10000 |
| MonthlyFee = 10 [symbol] | 10 |
| Deposit = 1000 [symbol] | 1000 |
| Withdrawal = 0 [symbol] | 0 |
| TransXnFee = .01 * (Withdrawal + Deposit) [symbol] | 10 |
| 100; Interest = .01 * Balance [symbol] | 224.92 |
| Balance = Balance + Interest + Deposit − | 23697.10 |
| Withdrawal − TransXnFee − MonthlyFee [symbol] | |
| Month = Month + 1 [symbol] | 12 |
| IF (Month < 12) GoTo 100 [symbol] | FALSE |

Tom's initial capital is $10000, he saves $12000 from wages and his wealth at the end of twelve months is $23697.10. Thus, the additional income he receives through Plan1 is $1697.10.

He now writes a model for Plan2. He can't invest monthly savings to earn interest; he can invest only the principal which starts earning interest after four months.

| | |
|---|---|
| Month = 1 [symbol] | 1 |
| Balance = 10000 [symbol] | 10000 |
| 100; IF (Month > 4) Interest = .01 * Balance | 229.74 |
| Balance = Balance + Interest [symbol] | 11716.59 |
| Month = Month + 1 [symbol] | 12 |
| IF (Month < 12) GoTo 100 [symbol] | FALSE |
| TotalBalance = Balance + 1000 * Month [symbol] | 23716.59 |

If he invests $10000 in Plan2 and hides his $12000 savings under his mattress, he would have $23716.59 at the end of 12 months. Thus, his investment income is $1716.59 which exceeds the income from Plan1.

Without the two models, Tom did not know which plan to select. He could not have guessed that the two plans offer similar income. If he is wise, and if the bank permits, he will invest $10000 in Plan2 and save $1000 each month in Plan1—i.e., he invests in both plans which is better than investing his capital in Plan2 and hiding the monthly savings under his mattress. At the end of twelve months, he will have the following amount in Plan1:

| | |
|---|---|
| Month = 1 [symbol] | 1 |
| Balance = 0 [symbol] | 0 |
| MonthlyFee = 10 [symbol] | 10 |
| Deposit = 1000 [symbol] | 1000 |
| Withdrawal = 0 [symbol] | 0 |
| TransXnFee = .01 * (Withdrawal + Deposit) [symbol] | 10 |
| 100; Interest = .01 * Balance [symbol] | 113.47 |
| Balance = Balance + Interest + Deposit − | 12440.01 |
| Withdrawal − TransXnFee − MonthlyFee [symbol] | |
| Month = Month + 1 [symbol] | 12 |
| IF (Month < 12) GoTo 100 [symbol] | FALSE |

By combining the two plans, he increases his wealth to: $12440.01+$11716.59=$24156.60.

However, there is more. The PAUSE command is useful for examining preliminary results, locating errors and revising them. The command permits Tom to observe the results at each iteration. Thus, after the first iteration, the screen reveals:

| | |
|---|---|
| Month = 1 [symbol] | 1 |
| Balance = 0 [symbol] | 0 |
| MonthlyFee = 10 [symbol] | 10 |
| Deposit = 1000 [symbol] | 1000 |
| Withdrawal = 0 [symbol] | 0 |
| TransXnFee = .01 * (Withdrawal + Deposit) [symbol] | 10 |
| 100; Interest = .01 * Balance [symbol] | 0 |
| Balance = Balance + Interest + Deposit − | 980 |
| Withdrawal − TransXnFee − MonthlyFee [symbol] | |
| Month = Month + 1 [symbol] | 1 |
| PAUSE [symbol] | PAUSE |
| IF (Month < 12) GoTo 100 | |

The results perplex him! He invests $1000 the first month into Plan1. The bank charges him $20 (i.e., a 1% transaction fee and a $10 monthly fee) but does not pay him interest until after 30 days. He wonders if he should pay the two fees of if he expects to receive only 1% interest on the amount deposited in Plan1? If his first month deposit is $980 (net deposit after the two fees), the interest he will earn after one month will be $9.80 which is less than $20 fees paid to the bank.

After pondering a bit, Tom decides that he ought to, nonetheless, invest in Plan1 because the transaction fee on each deposit made is charged once but the interest on that deposit is paid for all the subsequent months. The cumulative interest earned exceeds the cost of making the deposit. And, the monthly fee is applied to the amount maintained in the account. Initially, the monthly fee is a significant fraction of the balance. However, after a few months, the interest earned on the cumulative deposits made in the previous months exceeds the sum of the maintenance fee and the transaction fee applied each month.

Tom decides to invest his savings of $1000, each month, except for the last month, into Plan1. He does not invest the last month's saving because the interest he would earn on the final deposit is less than the transaction fee he would pay to make the deposit.

The inventive device empowers Tom to make better choices and to enhance his economic welfare. Simple models that can be easily modified reveal the best choices and suggest the best actions to pursue. Tom now recognizes the benefits and costs associated with various opportunities.

### EXAMPLE 15

Consider the income tax form. The government provides the tax filing rules in text-form in a booklet. We read and try to understand the rules and enter the amounts on a form at each line and use the calculator to compute our tax liability. If we could type the line items seen on the form, into a device, and enter the numbers, we would be empowered because we could make corrections and revisions and see what the tax liability would be under alternate circumstances.

How so? I can modify the data I supply at any line item or if I make a mistake in computing a line item, I can easily examine the entries and the expressions on the screen. All I do is revise a particular line-item and the device automatically computes the new result—i.e., the tax-owed to the government or the refind-owed to me. I would not have to re-type all the numbers in order to generate the result. I could also change some of the numbers, for some line-items, to understand how much I could save in the future and plan for it now.

What is claimed is:

1. A method for editing graphics, text and mathematical expressions in a file comprising:
entering expressions into a file;
marking a root-expression and copying it to a clipboard;
pasting the clipboard content to other locations via straight-link;
linking the pasted instance to the root-expression;
recording the locations of the root-expression and of the pasted instance into an ordered link-sequence.

2. A method as in claim one, which further comprises the user selecting an expression and viewing the link-sequence associated with the expression.

3. A method as in claim two, which further comprises the user selecting a particular linked instance, from the link-sequence, and locating it for examination.

4. A method for editing graphic, text and mathematical expressions in a file comprising:
entering expressions into a file;
marking a root-expression and copying it to a clipboard;
pasting the clipboard content to other locations via one-way-link;
linking the pasted instance to the root-expression;
recording the locations of the root-expression and of the pasted instance into an ordered link-sequence;
and, when revising a particular instance of the expression, only the subsequent linked instances are automatically updated and the corresponding results, where mathematical expressions are used, are automatically re-computed, saved and displayed.

5. A method for editing graphic, text and mathematical expressions in a file comprising:
entering expressions into a file;
marking a root-expression and copying it to a clipboard;
pasting the clipboard content to other locations via two-way-link;
linking the pasted instance to the root-expression;
recording the locations of the root-expression and of the pasted instance into a link-ring;
and, when revising any one particular instance of the expression in the link-ring, every linked instance is automatically updated and the corresponding results, where mathematical expressions are used, are automatically re-computed, saved and displayed.

6. A method for editing graphic, text and mathematical expressions in a file comprising:
entering expressions into a file;
labeling an expression;
referring to the labeled expression in other expressions via the label;
linking the labeled expression to the expression that refers to it;
recording the locations of the labeled expression and of the referring expression into an ordered link-sequence.

7. A method as in claim 6, which further comprises the user selecting an expression and viewing the link-sequence associated with it.

8. A method as in claim 7, which further comprises the user selecting a particular linked instance, from the link-sequence, and locating it for examination.

9. A method as in claim 6, which further comprises a method for revising an expression and automatically updating all linked expressions and their corresponding results, where mathematical expressions are used, and automatically re-computing, saving and displaying, each linked instance.

10. A method for editing graphic, text and mathematical expressions in a file comprising:
entering expressions into a file;
assigning a variable-name to an expression;
referring to the expression in other expressions via the variable-name;
linking the variable-named expression to the expression that refers to it;
recording the locations of the named expression and the referring expression into an ordered link-sequence.

11. A method as in claim 10, which further comprises the user selecting an expression and viewing the link-sequence associated with it.

12. A method as in claim 11, which further comprises the user selecting a particular linked instance, from the link-sequence, and locating it for examination.

13. A method as in claim 10, which further comprises a method for revising an expression and automatically updating all linked instances, and their corresponding results, where mathematical expressions are used, and automatically re-computing, saving and displaying, all linked instances.

14. A low-cost, portable device for creating and editing graphic, text, mathematical expressions comprising:
means for entering the expressions into a file accessible to the device;
means for storing the expressions;
means for displaying the storage contents;
means for processing the expressions;
means for storing, accessing and managing one or more files;
and, the improvements comprising:
means for revising the expressions in a well-developed editor;
and, means for interactively and automatically updating the storage and displaying the re-computed results, for the mathematical expressions, post-revision.

15. A device as in claim 14, which further comprises means for interactively and automatically updating the result of an expression, affected by a revision to a different expression, the storage and displaying modifications to all expressions and their corresponding re-computed results.

16. A device as in claim 14, which further comprises means for linking expressions via hyperlink, or straight-link, or paste-link, or a label, or a variable-name.

17. A device as in claim 16, which further comprises means for interactively and automatically updating the result of an expression, affected by a revision to a different expression, the storage and displaying modifications to all expressions and their corresponding re-computed results.

18. A low-cost, portable device for creating and editing graphic, text, mathematical expressions comprising:
means for entering the expressions into a file accessible to the device;
means for storing the expressions;
means for displaying the storage contents;
means for processing the expressions;
means for storing, accessing and managing one or more files;
and, the improvements comprising:
means for easily editing the expressions, including long text narratives, in a well-developed editor;
means for linking the expressions;
means for recording the links;
means for automatically updating, some or all, the linked instances when one particular instance is revised;
and, means for automatically and interactively updating the storage contents and displaying the new results, for the mathematical expressions, and executing user-provided instructions.

19. A low-cost, portable device for creating and editing graphic, text, mathematical expressions comprising:
means for entering the expressions into a file accessible to the device;
means for storing the expressions;
means for displaying the storage contents;
means for processing the expressions;
and, the improvements comprising:
means for easily editing the expressions, including long text narratives, in a well-developed editor;
means for linking the expressions;
means for recording the links;
means for automatically updating, some or all, the linked instances when one particular instance is revised;
and, means for updating the storage contents and displaying the new results, for the mathematical expressions, and executing user-provided instructions in batch mode.

20. A device as in claim 18, in which the links are recorded into either an ordered link-sequence or into a link-ring.

21. A device as in claim 14, where expressions can be entered by receiving from another device.

22. A device as in claim 14, where expressions can be entered via a full-sized QWERTY keypad for quick and easy typing.

23. A device as in claim 14, which further comprises a means for typing text in between mathematical and graphic expressions.

24. A device as in claim 18, which further comprises a means for locating various linked expressions for examination.

25. A device as in claim 14, which further comprises:
means for parsing and identifying errors and generating error messages, with or without suggestions, on the display means;
means for prompting the user for input to resolve the error;
means for accepting the input;
and, means for automatically updating all expressions affected by the user-provided input, executing the user instructions, updating the storage, and, displaying the modified expressions and the corresponding re-computed results for the mathematical expressions.

26. A device as in claim 14, which further comprises means for the user to supply a result of a mathematical expression whereby the processor compares it to the computed result and responds with a ‘Correct’/‘Incorrect’ response instead of displaying the computed result.
